(19) United States
(12) Patent Application Publication
(10) Pub. No.: US 2007/0007212 A1
(43) Pub. Date: Jan. 11, 2007

(54) Hydro-thermal energy and fire protection system

(76) Inventors: Thomas R. Harley, Indiana, PA (US); Gerry A. Mattern, Ligonier, PA (US); Geoffrey S. Miller, Belsano, PA (US)

Correspondence Address: THE BILICKI LAW FIRM, PC, 1285 North Main Street, JAMESTOWN, NY, 14701, US

(21) Appl. No.: 11/176,709

(22) Filed: Jul. 7, 2005

(51) Int. Cl. C02F 1/00

(52) U.S. Cl. 210/698

(57) ABSTRACT

The present invention is a geo-thermal energy system comprised of: at least one extraction pump that draws water from a natural water source; at least one heat exchanger, each of which provides an energy source, from which one or more corresponding buildings can extract heat to provide heating, or into which each building can reject heat to provide cooling; a first length of piping between the water source and the heat exchanger that delivers the water to each heat exchanger; a second length of piping that discharges the water after exiting each heat exchanger; and at least one diversion junction that is coupled to either the first or second length of piping and provides non-potable water to a fire protection system, or other potable water use, within each building. The discharged water is discharged back to the same water source, a second natural water source, a well, or a drainage system without adding any contaminants to the water.

### FIELD OF THE INVENTION

The subject invention relates generally to a hydro-thermal system for heating and/or cooling one or more buildings in a circuit as well as providing a non-potable water supply. More specifically, the invention is a hydro-thermal system that draws water from a natural water source, circulates it through an open-loop system to heat and/or cool businesses and homes, reserves a portion to be used in fire protection system and/or the like within the same buildings, and returns the water into the same or an alternate water source without adding any contaminants.

### BRIEF DESCRIPTION OF THE DRAWINGS

FIG. 1 is a schematic representation of an exemplary hydro-thermal system.

FIG. 2 shows one embodiment of an extraction pump positioned within a well.

FIG. 3 illustrates an alternate configuration of the extraction pump within the hydro-thermal system.

FIGS. 4a and 4b show a cross-sectional view and a top view, respectively, of one exemplary embodiment of a tap valve.

### DETAILED DESCRIPTION OF EMBODIMENTS OF THE INVENTION

For the purpose of promoting an understanding of the present invention, references are made in the text hereof to embodiments of a hydro-thermal system for heating and/or cooling one or more buildings, only some of which are illustrated in the drawings. It is nevertheless understood that no limitations to the scope of the invention are thereby intended. One of ordinary skill in the art will readily appreciate that modifications such as the shape of the system, the number or types of buildings in the loop, the number of units in each building, the types of pumps and piping, and the water source do not depart from the spirit and scope of the present invention. Some of these possible modifications are mentioned in the following description. Furthermore, in the embodiments depicted, like reference numerals refer to identical structural elements in the various drawings.

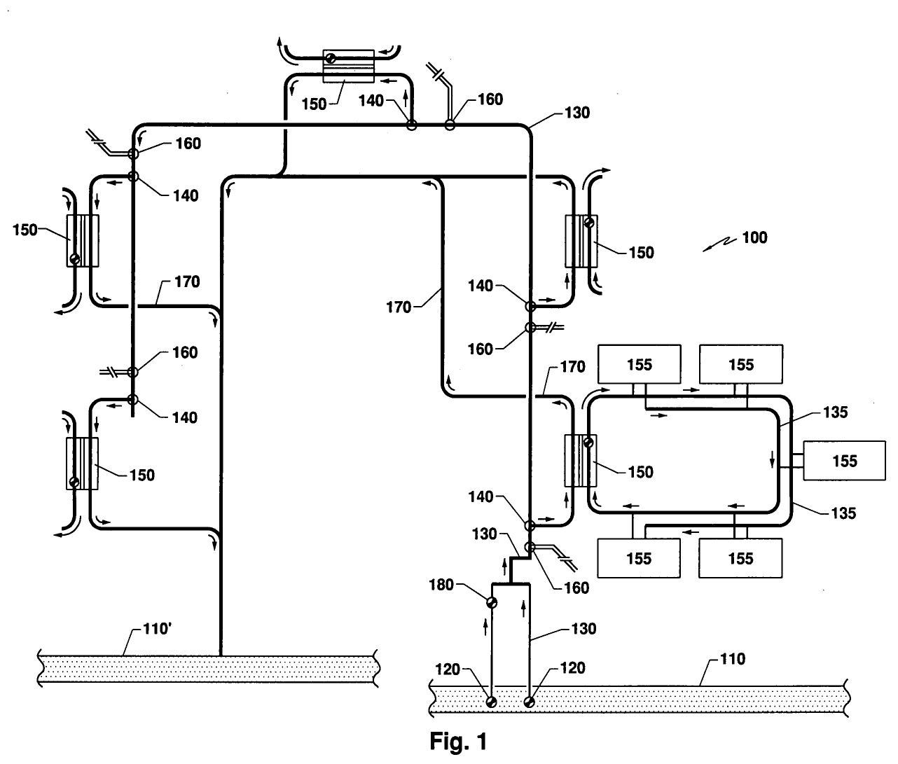

FIG. 1 shows an exemplary hydro-thermal system 100. Hydro-thermal system 100 provides two services to the client buildings: (1) heating and/or air conditioning, and (2) a non-potable water source. As shown, water is drawn out of water source 110 by two (2) extraction pumps 120. However, a single extraction pump 120 or more than two (2) extraction pumps 120 could be used to draw water from water source 110 depending on the number of buildings attached to system 100, the pumping capabilities of extraction pump(s) 120, and the number of units 155 in each building. Units 155 can be commercial units, residential units, or a combination thereof.

Two extraction pumps 120 lift water out of water source 110 and circulate it through pipeline 130, which, in this embodiment, is underground. Water source 110 could alternately be a river, an aquifer, and the like. In this embodiment, extraction pumps 120 are positioned within an aquifer.

Also visible in the embodiment of system 100 as shown in FIG. 1 is fire pump 180. System 100 is shown with a single fire pump 180. However, as with extraction pumps 120, the number of fire pumps 180 is not intended to be limiting. Multiple fire pumps 180 may be required, depending on the particular needs of an alternate embodiment of system 180. Whereas extraction pump 120 draws water into system 100, fire pump 180 provides adequate water pressure to system 100.

In one embodiment of system 100, fire pump 180 is a three-stage product lube UL and FM Armstrong® fire pump, model number 14LKM-FP as manufactured by S. A. Armstrong Ltd. Corporation®. Alternate fire pumps 180 include 125 HP, 142 Amp, Holloshaft or Solid Shaft, High Thrust RUS or RVS-4 fire pump as manufactured by U.S. Electrical Motors, Inc.®; Model 14LKM-FP, “A” discharge head, 1770 RPM, water lube vertical turbine electric fire pump as manufactured by Weir Pumps Ltd. Corp.®; vertical turbine fire pump model 12FCM, as manufactured by Aurora Pump Corp.™; and vertical turbine fire pump model VT as manufactured by Reddy-Buffaloes Pump Co., Inc.®

As stated supra, the use of two extraction pumps 120 is only exemplary and not intended to be limiting. Each building then taps into pipeline 130 via tap valve 140. In the embodiment shown in FIG. 1, there are five (5) buildings that tap into pipeline 130. However, one of ordinary skill in the art will recognize that the number of buildings that tap into pipeline 130 is only exemplary and any number of buildings can be in system 100. In the embodiment shown in FIG. 1, tap valve 140 is a “curb box and valve,” but one of ordinary skill in the art will recognize that any type of valve could be used that can handle the water volume and pressure. A portion of the water drawn from water source 110 is extracted and then pumped through one or more heat exchangers 150, each building is a closed loop having its own heat exchanger 150. The reminder of the water extracted from water source 110 then passes on to the next building, where a portion is extracted by that building, and so on.

In addition, a portion of the water is diverted by diversion junction 160 to be used as or as a portion of the building's non-potable water supply, e.g., toilets, showers, lawn care, or fire protection system. In the embodiment shown, the diverted water is used in the building as the fire protection system. In this embodiment, the diverted water is fluidly connected directly to the building's fire protection system entrance to supply water to the fire protection system. Also in the embodiment shown, diversion junction 160 is positioned on the main loop, in advance of heat exchanger 150 and in advance of tap valve 140. This is because the non-potable water is to be used on the buildings' fire protection systems. However, if the water is to be used in an alternate non-potable use, diversion junction 160 could be located after tap valve 140, but before heat exchanger 150 or after heat exchanger 150 on exhaust pipeline 170.

Once the water enters heat exchanger 150, pipeline 130 flows through one side of heat exchanger 150 inside the building and building water within building piping 135 flows through a closed loop system through the other side of heat exchanger 150. The building or each unit 155 within the building (for those buildings with multiple tenants, as shown in FIG. 1) either transfers heat into or extracts heat from the water. The heating and/or cooling service either draws energy from or adds energy to the water within building piping 135, which is a closed-loop system, as needed to provide cooling or heating to the building or units 155 within the building.

After the water drawn from water source 110 passes through heat exchanger 150, the water enters exhaust pipeline 170, where it is either returned to the same water source 110 or to an alternate water source. In the embodiment shown, the water that has passed through any of heat exchangers 150 is redeposited directly into alternate water source 110′. In this embodiment, because the system does not add any additional chemicals or materials to the water, i.e., the system is a two-loop system with only heat passing between the two loops, the water can be exhausted without any adverse environmental effects. The only difference between the water extracted from water source 110 and the water discharged is that the discharged water will have a slightly elevated temperature during cooling and a slightly reduced temperature during heating. In almost all cases, the change in temperature will be less than two degrees Fahrenheit (2° F.). In an embodiment in which the water extracted is from a river, the exhaust water may actually be cleaner than when extracted because the river water is filtered and cleaned before entering system 100. In addition, the exhaust water could instead be deposited in an alternate water source such as an aquifer, into the individual buildings' already existing drainage or storm water systems, into a well, or combinations thereof.

In an alternate embodiment of system 100, the water that passes through heat exchanger 150 is not directed into exhaust pipeline 170. Rather, after passing through heat exchanger 150, the water enters the next heat exchanger 150. However, as the water will be slightly heated, each subsequent heat exchanger 150 will operate less efficiently.

Because the temperature of water source 110, when an aquifer, is substantially constant, the parameters of system 100 can be set to maximize efficiency of system 100. As a rule, one (1) ton of air conditioning is produced at three gallons of flow per minute (3 gal/min). However, by setting system 100 for the specific temperature of the water drawn from water source 110, one (1) ton of air conditioning can be produced at one gallon of flow per minute (1 gal/min), i.e., three times the tonnage of air conditioning can be produced for the same flow rate. For example, using an exemplary flow rate of 1,250 gal/min, a typical system will produce 417 tons of air conditioning. However, by setting system 100 to the specific temperature of the extracted water, 1,250 tons of air conditioning can be produced at the same flow rate.

As stated supra, the embodiment of system 100 shown in FIG. 1 employs two (2) extraction pumps 120 and one (1) fire pump 180. In an alternate embodiment of the hydrothermal system, only one (1) pump is used. That is, the same pump is used to both draw water into the system and provide pressure within the system. For a system in which the non-potable water use is not for fire protection, any type of pump can be used, but for a system in which the non-potable use is for fire protection, the single pump must be a fire pump.

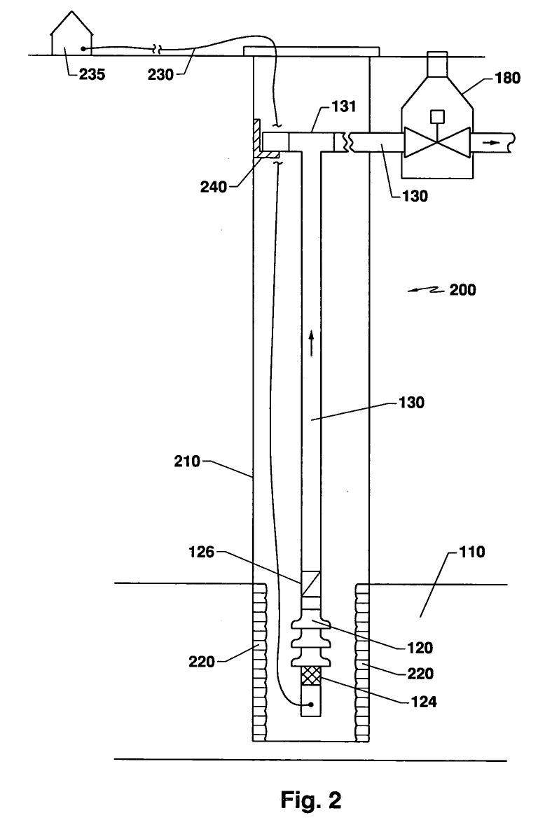

As stated supra, water is extracted from water source 110 via one or more extraction pumps 120. FIG. 2 shows one embodiment of extraction pump 120 and the positioning of it relative to water source 110. In the embodiment of extraction pump 120 shown in FIG. 2, extraction pump is positioned in well 200, which is approximately sixty feet (60′) deep and twenty four inches (24″) wide. Well 200 is comprised of well casing 210 which provides structural support to well 200 and provides a direct point of extracting water from water source 110. Also shown in this embodiment are well screens 220 which filter out solid contaminants within water source 110 to prevent damaging extraction pump 120 or any of the other components of the system. Well screens 220 are made of stainless steel, but can be made of any material that is sufficiently strong and corrosion resistance.

In the embodiment shown, extraction pump 120 is a two-stage, water lubricated, submersible turbine well pump with stainless steel fasteners and class “F” 1600 V insulation, Franklin™ premium efficient motor rated for inverter duty, and capable of producing 125 HP and 3600 RPM and of pumping approximately one thousand (1,000) gallons per minute, model number 10MC as manufactured by American-Marsh Pumps™. The discharge of this pump has an eight inch (8″) diameter, but could also have a six inch (6″) diameter. An appropriately sized pipeline 130, discussed in detail infra, would then be necessary.

However, the pump discussed immediately supra is not intended to be limiting. An example of an alternate extraction pump 120 is any eight inch (8″) encapsulated submersible motor as manufactured by Franklin Electric Co., Inc.® Depending on the system requirements, two specific examples of alternate extraction pumps 120 are model number 239-651-20, which operates at 50 HP and 37 kW to produce 3,525 RPM at 60 Hz and 2,900 RPM at 50 Hz, and model number 239-652-20, which operates at 60 HP and 45 kW to also produces 3,525 RPM at 60 Hz and 2,900 RPM at 50 Hz.

Extraction pump 120 is also further comprised of pump screen 124 to further reduce the likelihood of solid contaminants being introduced to the system and check valve 126 to ensure that water flows in only one direction through the system. As with well screens 220, pump screen 124 is also made of stainless steel, but could similarly be made of any sufficiently strong and corrosion resistant material.

Also visible in the embodiment of extraction pump 120 and well 200 as shown in FIG. 2 are power cord 230 and support 240. Power cord 230 is connected to extraction pump 120 and provides electrical power from an outside power source to extraction pump 120. In one embodiment, the other end of power cord 230 is kept within power station 235 (not shown to scale), e.g., a small shed. In the station is a disconnect switch which terminates power to extraction pump 120 in the event that it is necessary. Moreover, the power station can also include a monitoring station that provides an operator with information about the power source, extraction pump 120, conditions of well 200, conditions of the water, and the like. Power station 235 is located above ground to provide access by authorized personnel and protects the disconnect switch, the monitoring station, and anything else within power station 235, e.g. spare parts for extraction pump 120 and tools. The use of power station 235 also provides for a minimal adverse affect on the aesthetics of the immediately surrounding area while protecting the elements contained therein. Support 240 provides a foundation to support pipeline 130 and pipeline joint 131.

In one embodiment of the invention, system 100 is further comprised of an emergency generator (not shown, but also located within power station 235). The emergency generator provides electric power to extraction pump 120 in the event of a loss of power from the primary power source. In this embodiment, the emergency generator is also within power station 235 to protect the emergency generator and to minimize noise emissions. Power is supplied from the emergency generator to extraction pump 120 by the same power cord 230 or could alternately be supplied using a second power cord.

One exemplary emergency generator is a 125 HP, Weather-Protected I, high thrust, premium efficient type RUS generator as manufactured by U.S. Electrical Motors, Inc.® Another exemplary emergency generator is a 6081AF001 Engine, Model SED230FRJ4, 230 kW, 287.5 kVA, three phase, 277/480 Volt, 0.8 PF, 60 Hz, 12 Leads, 1800 RPM, Katolight® diesel engine generator set, as manufactured by Katolight Corporation®, with or without a Model CPJ series compact silencer, also manufactured by Katolight Corporation®. Both of these exemplary emergency generators satisfy the requirements for Level 1, Type 10, Class 8 systems as defined by NFPA 110 (National Fire Protection Association Standard 110), entitled “Standard for Emergency and Standby Power Systems.” Level 1 indicates that generators are “critical” to life safety; Type 10 generators provide power within ten (10) seconds after a power loss; and Class 8 generators have sufficient fuel to operate for eight (8) hours at one hundred percent (100%) capacity of the pump and other demands. One of ordinary skill in the art will recognize that alternate emergency generators meeting these NFPA 110 requirements (i.e., the “Standards for Emergency and Standby Power Systems” if system 100 is used to supply water to a fire protection system), or alternate specifications depending on the particular system requirements, could also be used if, for example, system 100 is used to provide water to an alternate potable water application.

Upon a loss of power, an automatic transfer switch is necessary to automatically switch the system from its primary power source to using the emergency generator as the power source. One such transfer switch is model number ZTGD00A0040E-N0140MSTDG as manufactured by GE® Zenith Controls, Inc.®, or alternately any other transfer switch from their ZTG series. Further alternate transfer switches should have a proper UL listing, an adequate fault current withstanding rating, an adequate load rating to match the generator, controls as required by the National Electric Code (NEC), and should comply with sections 701 and 702 of the NEC, entitled “Legally Required Standby Systems” and “Optional Standby Systems,” respectively.

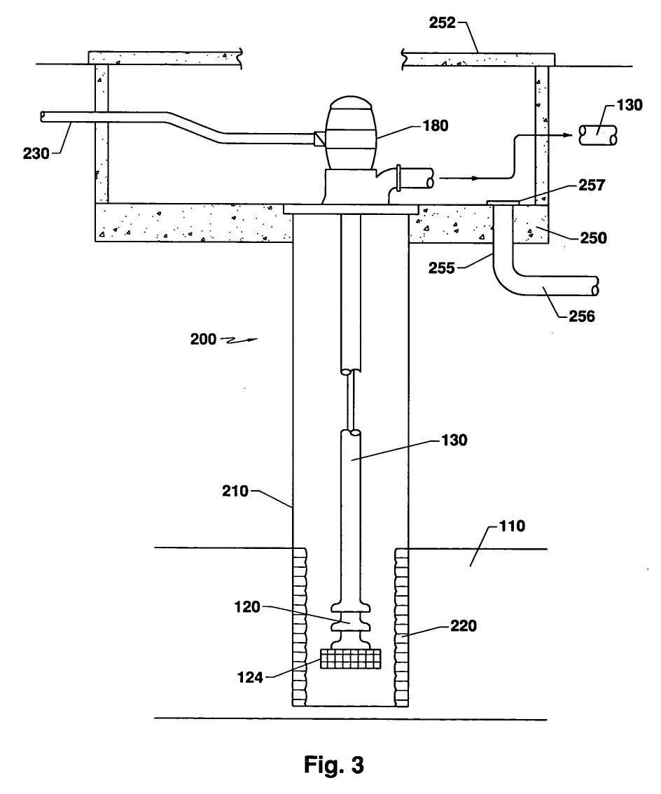

FIG. 3 illustrates an alternate configuration of extraction pump 120. In this embodiment, extraction pump 120 draws water from water source 110, and the water passes through both well screens 220 and pump screen 124 to filter out solid contaminants within water source 110 to prevent damaging extraction pump 120 or any of the other components of the system, as with the embodiment shown in FIG. 2. However, rather than extraction pump 120 being immersed in water source 110, extraction pump 120 is encased within vault 250 and pipe 130 extends into water source 110, which is, in this embodiment, an aquifer which can be as much as two hundred to three hundred feet (200′ to 300′) below the surface. In this embodiment, vault 250 is made of concrete and is positioned under either earth or pavement. In order to further secure vault 250, a gravel bed (not shown) can be laid under vault 250. Vault cover 252 provides access to vault 250 and extraction pump 120 contained therein, as well as a portion of pipeline 130.

Also visible in this embodiment is floor drain 255, comprised of floor drain pipe 256 and cover 257, which permits any water that leaks within vault 250 to be removed. In the embodiment shown, floor drain pipe 256 is a two inch (2″) PVC pipe and is also accessible via vault cover 252.

Again, the embodiment shown in FIG. 3 provides only a single extraction pump 120, but multiple extraction pumps 120, either within the same vault 250 or in separate vaults 250, could be employed. Furthermore, any of the types of pumps discussed supra could be employed in this embodiment as well.

One embodiment of pipeline 130, as shown in any of the Figures provided supra, is eight inch (8″) Certa-Lok C900/RJ Restrained Joint PVC Pipe, as manufactured by CertainTeed Corporation®. An alternate embodiment of the system uses ten inch (10″) pipeline 130, which provides the same volume of water to be extracted, but at a lower pressure within the system. Another alternate pipeline 130 is eight inch (8″) or ten inch (10″) Tyton Joint™ pipe as manufactured by United States Pipe and Foundry Company®. However, any piping capable of handling the volume and rated for 200 PSI hydrostatic test (as required by NFPA 24, Private Fire Lines) is acceptable. Moreover, any combination of acceptable piping could be used throughout the system. That is, while pipeline 130 and exhaust pipeline 170, for example, could be the same piping and with the same diameter, they need not be.

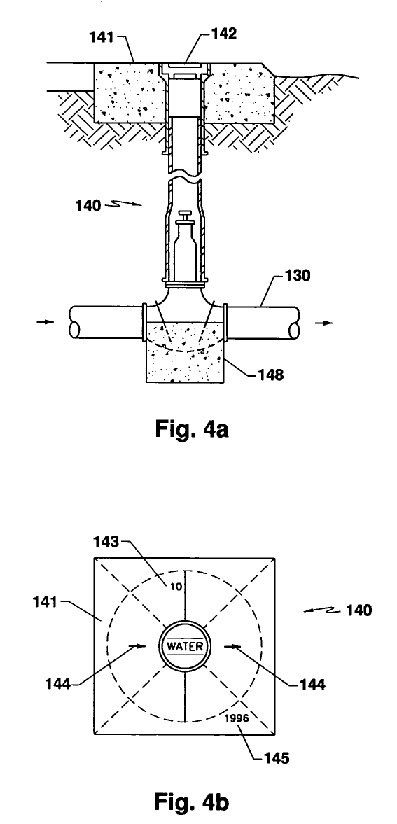

FIGS. 4a and 4b show a cross-sectional view and a top view, respectively, of one exemplary embodiment of tap valve 140. In this embodiment, tap valve 140 is positioned underground, but includes access from the surface to tap valve 140. As can be seen in FIG. 4a, collar 141, which is flush with paving or sidewalk, supports and allows access to tap valve 140 via cover 142. Collar 141 is, in this embodiment, made of concrete and measures eight inches by eight inches (8″×8″). Cover 142 is typically metal and has a marking disposed thereon to identify the specific tap valve 140.

As provided supra, tap valve 140 is a curb box and valve assembly. In the embodiment shown, top valve 140 is comprised of a Kenseal II™ valve as manufactured by Kennedy Valve Mfg. Co., Inc.™; the valve ends are mechanical joints; and the curb box is a five and one quarter inch (5¼″) shaft, two-piece, screw-type adjustable valve box, constructed of cast iron and manufactured by Bingham & Taylor Corporation™. However, one of ordinary skill in the art will recognize that any valve/curb box that has a resilient seal and tight shutoff valve, an adjustable and corrosion-resistant curb box, and mechanical joint ends for underground service could alternately be employed. Also visible in FIG. 4a is thrust block 148 which maintains the position of tap valve 140 and pipeline 130.

FIG. 4b is a top view of the same tap valve 140 as shown in FIG. 4a. From this perspective, identifying markings 143, 144, and 145 can all be appreciated. Identifying marking 143 provides the valve size; identifying marking 144 indicates the flow direction of the water; and identifying marking 145 provides the year tap valve 140 was installed. Each of these markings 143, 144, and 145 are one half inch (½″) deep and can be painted. One of ordinary skill in the art will recognize, however, that the identifying markings 143, 144, and 145 shown in FIG. 4b are only non-limiting examples.

As provided supra, each building has its own heat exchanger 150, from which each building of the system draws energy for use in heating and/or cooling the building. One exemplary heat exchanger 150 is Model GB210-120, MicroHeat™ Brazed Plate heat exchanger as manufactured by Graham Corporation™. However, alternate heat exchangers 150 could be used in the embodiment of system 100 shown and described in FIG. 1 as long as the alternate heat exchanger is constructed of corrosion-resistant materials, includes brazed plate construction, has an optimized heat transfer rate, and further has an optimized pressure drop. In addition, other heat exchanges could be used in alternate systems as long as they satisfy the operational requirements of the alternate system.

Diversion junction 160 permits a portion of the water extracted from water source 110 to be used for the fire protection system (or other non-potable, industrial uses), allowing a portion of the extracted water to rest within the sprinkler system until needed. One example of diversion junction 160 is a Y-shaped ductile iron mechanical joint fitting as manufactured by United States Pipe and Foundry Company®.

Although, for convenience, the invention has been described primarily with reference to specific embodiments, it will be apparent to those of ordinary skill in the art that the mirror assembly and the components thereof can be modified without departing from the spirit and scope of the invention as claimed.

What is claimed is:

1. A system comprised of:
at least one extraction pump, wherein each of said at least one extraction pump draws water from a natural water source;
at least one fire pump, wherein each of said at least one fire pump provides pressure within said system;
at least one heat exchanger, wherein each of said at least one heat exchanger provides a source for one or more corresponding buildings to draw energy from to provide heating and into which to deposit energy from one or more corresponding buildings to provide cooling to said one or more corresponding buildings;
a first length of piping, wherein said first length of piping delivers said water to each of said at least one heat exchanger;
a second length of piping, wherein said second length of piping discharges said water from each of said at least one heat exchanger to a location selected from a group comprised of said natural water source, a second natural water source, a well, and a drainage system;
at least one tap valve, wherein each of said at least one tap valve provides said water to one of said one or more corresponding buildings; and
at least one diversion junction, each of said at least one diversion junction mechanically coupled to either said first length of piping or to said second length of piping for delivering said water to at least one non-potable water system, each of said at least one non-potable water system being within one of said at least one corresponding buildings.

2. The system of claim 1, wherein said natural water source and said second natural water source is selected from a group comprised of an aquifer, a river, and a lake.

3. The system of claim 1, wherein said system further includes an emergency generator to provide an alternate power source in the event of a loss of power.

4. The system of claim 1, wherein each of said at least one diversion junction is positioned on said first length of piping in advance of said at least one tap valve, on said first length of piping between said at least one tap valve and said at least one heat exchanger, or on said second length of piping.

5. The system of claim 1, wherein said at least one non-potable water system is selected from a group comprised of sanitation, showers, lawn care, and a fire protection system.

6. The system of claim 1, wherein each of said at least one tap valve is positioned within a vault to provide access to each of said at least one tap valve.

7. A hydro-thermal energy system comprised of:
at least one extraction pump, wherein each of said at least one extraction pump draws water from a water source;
at least one fire pump, wherein each of said at least one fire pump provides pressure within said system;
at least one heat exchanger, wherein each of said at least one heat exchanger provides a source for one or more corresponding buildings to draw energy from to provide heating and into which to deposit energy from one or more corresponding buildings to provide cooling to said one or more corresponding buildings;
a first length of piping, wherein said first length of piping delivers said water to each of said at least one heat exchanger;
a second length of piping, wherein said second length of piping discharges said water from each of said at least one heat exchanger;
at least one tap valve, wherein each of said at least one tap valve provides said water to one of said one or more corresponding buildings; and
at least one diversion junction, wherein each of said at least one diversion junction is mechanically coupled to either said first length of piping or to said second length of piping and delivers said water to a fire protection system within each of said one or more corresponding buildings.

8. The system of claim 7, wherein said natural water source and said second natural water source is selected from a group comprised of an aquifer, a river, and a lake.

9. The system of claim 7, wherein said system further includes an emergency generator to provide an alternate power source in the event of a loss of power.

10. The system of claim 7, wherein each of said at least one diversion junction is positioned on said first length of piping in advance of said at least one tap valve, on said first length of piping between said at least one tap valve and said at least one heat exchanger, or on said second length of piping.

11. The system of claim 7, wherein each of said at least one tap valve is positioned within a vault to provide access to each of said at least one tap valve.

12. An energy system comprised of:
at least one extraction pump, each of said at least one extraction pump drawing water from a water source;
at least one fire pump, each of said at least one fire pump providing pressure within said system;
at least one heat exchanger, each of said at least one heat exchanger providing a source for one or more corresponding buildings to draw energy from to provide heating and into which to deposit energy from one or more corresponding buildings to provide cooling to said one or more corresponding buildings;
a first length of piping, said first length of piping delivering said water to each of said at least one heat exchanger;
a second length of piping, said second length of piping discharging said water from each of said at least one heat exchanger;
at least one tap valve, each of said at least one tap valve providing said water to one of said one or more corresponding buildings; and
at least one diversion junction, each of said at least one diversion junction mechanically coupled to either said first length of piping or to said second length of piping for delivering said water to a fire protection system within each of said one or more corresponding buildings; and
an emergency generator for providing an alternate source of power in the event of a power loss to said energy system.

13. The energy system of claim 12, wherein said natural water source and said second natural water source is selected from a group comprised of an aquifer, a river, and a lake.

14. The energy system of claim 12, wherein each of said at least one diversion junction is positioned on said first length of piping in advance of said at least one tap valve, on said first length of piping between said at least one tap valve and said at least one heat exchanger, or on said second length of piping.

15. The energy system of claim 12, wherein each of said at least one tap valve is positioned within a vault to provide access to each of said at least one tap valve.

16. A combined hydro-thermal energy and fire protection system comprised of:
at least one fire pump, wherein each of said at least one fire pump draws water from a natural water source and provides pressure within said system;
at least one heat exchanger, wherein each of said at least one heat exchanger provides a source for one or more corresponding buildings to draw energy from to provide heating and into which to deposit energy from one or more corresponding buildings to provide cooling to said one or more corresponding buildings;
a first length of piping, wherein said first length of piping delivers said water to each of said at least one heat exchanger;
a second length of piping, wherein said second length of piping discharges said water from each of said at least one heat;
at least one tap valve, wherein each of said at least one tap valve delivers said water to one of said one or more corresponding buildings; and
at least one diversion junction, wherein each of said at least one diversion junction is mechanically coupled to said first length of piping in advance of said at least one tap valve to deliver said water to a fire protection system within one of said at least one corresponding buildings.

17. The system of claim 16, wherein said natural water source is selected from a group comprised of an aquifer, a river, and a lake.

18. The system of claim 16, wherein said system further includes an emergency generator to provide an alternate power source in the event of a loss of power.

19. The system of claim 16, wherein each of said at least one tap valve is positioned within a vault to provide access to each of said at least one tap valve.

20. The system of claim 16, wherein said second length of piping discharges said water to a location selected from a group comprised of said natural water source, a second natural water source, a well, and a drainage system.

21. A method for providing energy for a heating and cooling system to at least one building in series, said method comprising the steps of:
drawing water into said system using at least one extraction pump;
providing pressure within said system using at least one fire pump;
pumping said water to at least one heat exchanger, said at least one extraction pump in fluidly connected with said at least one heat exchanger by a first length of piping and each of said at least one heat exchanger corresponding to a corresponding building;
transferring a portion of energy across said at least one heat exchanger to heat or cool said corresponding building;
discharging said water once it has passed through said at least one heat exchanger, said discharging being accomplished with a second length of piping; and
extracting a portion of said water from said first length of piping or said second length of piping, said portion of said water being used for a fire protection system within said corresponding building.

22. The method of claim 21, wherein said drawing step draws water from a natural water source, said natural water source selected from a group comprised of an aquifer, a river, and a lake.

23. The method of claim 21, wherein said system further includes an emergency generator to provide an alternate power source in the event of a loss of power.

24. The method of claim 21, wherein said extracting step occurs a diversion junction, said diversion junction positioned on said first length of piping or on said second length of piping.
